(19) United States
(12) Patent Application Publication
(10) Pub. No.: US 2007/0233747 A1
(43) Pub. Date: Oct. 4, 2007

(54) Meta Data Conversion Device, Meta Data Conversion Method, And Meta Data Conversion System

(75) Inventors: Yoshiaki Tomioka, Chiba-ken (JP); Toru Kawaguchi, Tokyo (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/569,293

(22) PCT Filed: May 13, 2005
(86) PCT No.: PCT/JP05/08743

§ 371 Date: Nov. 17, 2006

(30) Foreign Application Priority Data
May 18, 2004 (JP) JP 2004-147919

(51) Int. Cl. G06F 17/30

(52) U.S. Cl. 707/200

(57) ABSTRACT

It is to provide a meta data conversion device for converting to meta data in line with a purpose of a content provider when generating meta data for digest viewing or when selecting segmentation meta data. Thus, there is provided a meta data conversion device including: a meta data database for storing meta data; a use condition input part for inputting a use condition for converting the meta data; a scene section information input part for inputting scene section information for converting the meta data; a meta data conversion part for converting selected meta data to the meta data in line with the purpose of the content provider, using the use condition or the scene section information; and a meta data use/reproduction part for reproducing the content using the converted meta data.

### BACKGROUND OF THE INVENTION

1. Technical Field of the Invention

The present invention relates to a meta data conversion device for converting meta data in accordance with meta data conversion information.

2. Description of the Related Art

In server-type broadcasting using content that is temporarily accumulated in a memory device of a receiving terminal, it is possible to grant meta data which is information relating to the content. The meta data includes segmentation meta data to grant information relating to the scenes that constitute the content. The use of the segmentation meta data has allowed a user to view a digest in line with the user's preference on the receiving terminal side, where the user can not only know the scene information of the content but also start viewing from the scene, select only the scene the user wants to view, and change its viewing order.

Meanwhile, a content provider intends to cause the user to view not only the content but also commercial messages (CM) together with the content. In order to allow the user to view the CM together with the content, there is disclosed a technology that the content provider grants information as meta data capable of discriminating the CM from other scenes, to the CM scene included in the content and transmits the meta data to the receiving terminal (see Patent Document 1).

Patent Document 1: Japanese Patent Publication Laid-Open No. 2003-134436

### SUMMARY OF THE INVENTION

However, the user can easily generate meta data for digest viewing without selecting the CM scene and other scenes that the content provider considers important. The meta data generated by the user is used to view the content in accordance with the generated meta data. Thus, the scenes that the content provider originally intended and considers important are not viewed by the user. Also, the order of scenes that the content provider intended and considers important is likely to be changed. As a result, there is a problem that the intended scenes including the CM scene that the content provider wants to be viewed are not viewed by the user and the scenes are not viewed in the order as it is intended.

The present invention is made in light of the above described problem, and its object is to provide a meta data conversion device for converting to meta data suited to the scenes and order of scenes that the content provider intends, when viewing a digest or selecting segmentation meta data in order to reproduce from the scene halfway through the content.

To achieve the above described object, according to the invention, a meta data conversion device includes: a meta data input part that inputs meta data that describes information on content in units of scenes; an input part that inputs a scenario rule indicating a conversion method for meta data provided by a content provider; and a meta data conversion part that converts the input meta data by the conversion method described in the scenario rule.

With such a configuration, it is possible to provide the user with important scenes (highlight scenes, CM scenes and others) that the content provider specifies as required scenes.

In the meta data conversion device according to the invention, the scenario rule can include a use condition for converting the meta data and scene section information for converting the meta data. The use condition can specify at least one specification, which is a required scene or a scene reproduction order to be viewed.

The meta data conversion device according to the invention further includes a meta data discrimination part that discriminates a publisher of the input meta data, wherein the meta data conversion part can change a conversion result of the meta data converted by the conversion method described in the scenario rule, depending on a discrimination result of the publisher. The meta data conversion device still further includes a content purchase confirmation part that confirms whether content corresponding to the meta data has been purchased, wherein the meta data conversion part can change the conversion result of the meta data converted by the conversion method described in the scenario rule, depending on the purchase confirmation result.

Further, in the meta data conversion device according to the invention, the meta data conversion part can use the use condition to perform at least one conversion process, which is insertion of the required scene into the meta data or rearrangement of the scenes in the order to be viewed. The meta data conversion part can include: a first meta data conversion part that converts the input meta data to meta data in units of scenes of the scene section information specified by the input scene section information; and a second meta data conversion part that converts the meta data converted in the first meta data conversion part, based on the input use condition.

Further according to the invention, a meta data conversion information providing device includes: a meta data conversion information generation part that generates a scenario rule including a use condition and scene section information for converting meta data that describes information on content in units of scenes; and a transmission part that transmits the scenario rule.

Further according to the inventions a meta data conversion method includes the steps of: inputting a scenario rule to convert meta data in a terminal in accordance with a meta data conversion rule generated by a content provider; converting specified meta data using the scenario rule; and reproducing the content using the converted meta data.

The meta data conversion method according to the invention can further include the steps of: discriminating a publisher of the meta data; and changing a conversion result depending on a discrimination result of the publisher. Alternatively, in place of the above steps, the meta data conversion method can further include the steps of: confirming whether content corresponding to the meta data has been purchased; and changing a conversion result depending on a purchase confirmation result.

In the meta data conversion method according to the invention, the step of converting the meta data can include: a first meta data conversion step for sorting the input meta data in units of scenes of the scene section information specified by the input scene section information, based on the input use condition; and a second meta data conversion step for converting the meta data converted in the first meta data conversion step, based on the input use condition.

Further according to the invention, a digest reproduction device includes: a meta data input part that inputs meta data that describes information on content in units of scenes; an input part that inputs a scenario rule indicating a conversion method for meta data provided by a content provider; a meta data conversion part that converts the input meta data by the conversion method described in the scenario rule; and a meta data use/reproduction part that reproduces the content using the converted meta data.

Further according to the invention, a meta data conversion system includes: a meta data conversion information providing device that provides meta data conversion information; a meta data conversion device that converts meta data; and a transmission line that connects the meta data conversion information providing device with the meta data conversion device. The meta data conversion information providing device includes: a scenario rule generation part that generates a scenario rule generated by the content provider; and a transmission part that transmits the scenario rule. The meta data conversion device includes: a use condition input part that receives and inputs the use condition; a scene section information input part that receives and inputs the scene section information; a meta data conversion part that converts the meta data using the use condition or the scene section information; and a meta data use/reproduction part that reproduces the content using the converted meta data.

According to the invention, it is possible to provide a user with important scenes (highlight scenes, CM scenes and others) that a content provider specifies as required scenes, even in the case where the user selects meta data for digest viewing not including the important scenes (highlight scenes, CM scenes and others) specified by the content provider. Also even in the case where the user arbitrary selects meta data and changes the viewing order, it is possible to provide the user with the meta data rearranged in the order that the content provider wants to be viewed by the user.

The above object and advantages of the present invention will become more apparent by the following descriptions of the preferred embodiments thereof with reference to the accompanying drawings.

### BRIEF DESCRIPTION OF THE DRAWINGS

FIG. 1 is a block diagram showing the configuration of a meta data conversion system according to a first embodiment of the invention;

FIG. 2 is a view showing an example of the description of a use condition in the first embodiment;

FIG. 3 is a view showing an example of the description of scene section information in the first embodiment;

FIG. 4 is a block diagram showing the internal configuration of a meta data conversion part in the first embodiment;

FIG. 5 is a flowchart showing the operation for converting to meta data in line with the purpose of a content provider;

FIG. 6 is a flowchart showing the operation processed within the meta data conversion part in the first embodiment;

FIG. 7 is a view showing an example of the description of meta data in line with the purpose of the content provider in the first embodiment;

FIG. 8 is a block diagram showing the configuration of a meta data conversion system according to a second embodiment of the invention;

FIG. 9 is a view showing an example of the description of a use condition to which the publisher of meta data is granted in the second embodiment;

FIG. 10 is a block diagram showing the internal configuration of the meta data conversion part in the second embodiment;

FIG. 11 is a block diagram showing the configuration of a meta data conversion system according to a third embodiment of the invention;

FIG. 12 is a view showing an example of the description of a use condition to which a viewing restriction is granted in the third embodiment;

FIG. 13 is a view showing an example of the meta data in the first embodiment;

FIG. 14 is a view showing an example of the scene section information in the first embodiment;

FIG. 15 is a view showing an example of the use condition in the first embodiment; and

FIG. 16 is a view showing an example of the meta data after conversion in the first embodiment.

### DETAILED DESCRIPTION OF THE PREFERRED EMBODIMENTS

Hereinafter, preferred embodiments for carrying out the present invention will be described with reference to the accompanying drawings. It is to be understood that the present invention is by no means limited to the embodiments described below and may be modified and carried out accordingly without departing from the sprit and scope of the present invention.

### Embodiment 1

The invention is briefly described that converts meta data by applying a scenario rule that the content provider provides including a use condition that defines the scenes and scene order to be viewed, and a scene section indicating the scene segmentation of the content and the like.

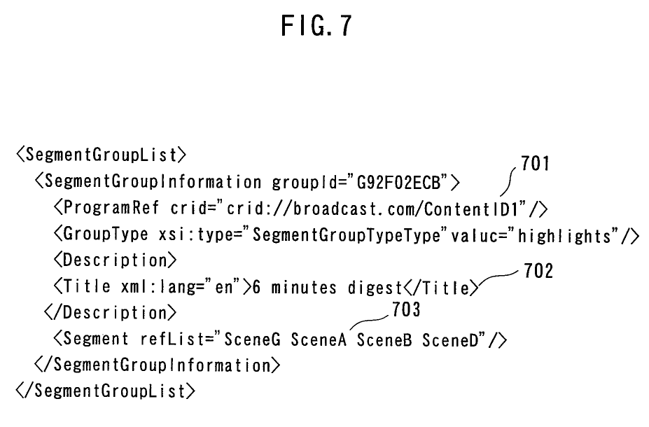

The meta data mainly described in the invention is meta data that describes information on content which is time-divided into units of scenes (a more detailed explanation will follow in the description of FIG. 3 later). There may be also included the meta data that describes the scene structure information to sort and order the described units of scenes. Incidentally, the meta data for allowing the user to view a digest, which will be described in detail below with reference to FIG. 7, is meta data that describes the units of scenes and the order of scenes.

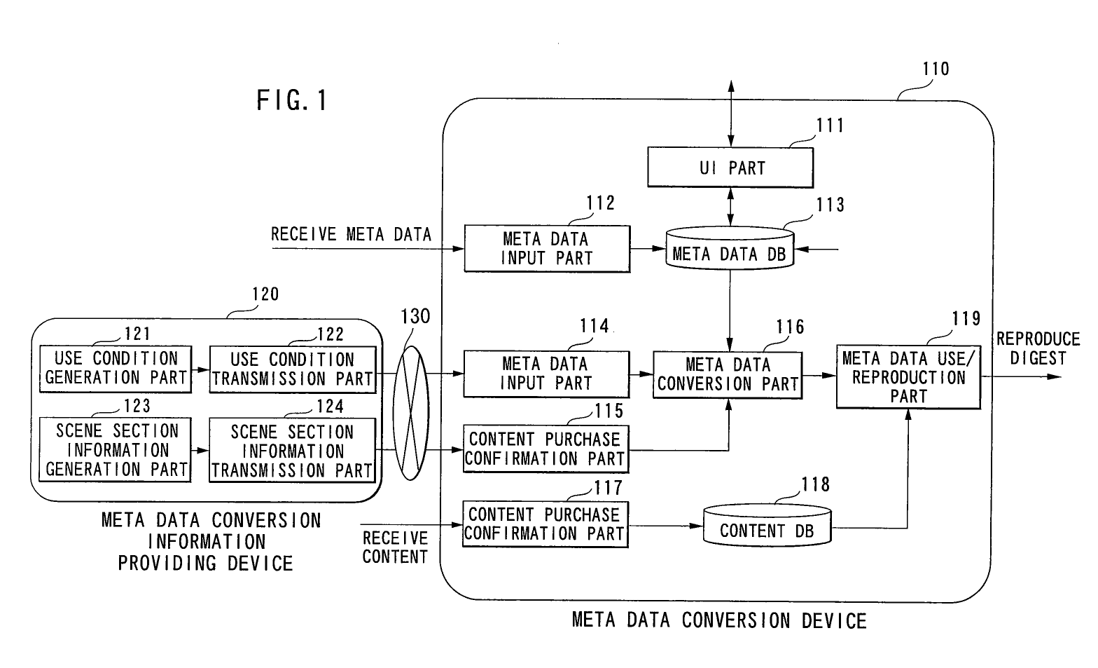

Hereinafter, the first embodiment of the invention will be described. As shown in FIG. 1, the meta data conversion system in this embodiment includes: a meta data conversion device 110 for converting meta data to meta data in line with the intent and purpose of a content provider; a meta data conversion information providing device 120 for providing meta data conversion information; and a transmission line 130 for connecting the meta data conversion device 110 and the meta data conversion information providing device 120 with a broadcast network or other communication networks.

Within the meta data conversion device 110 there are included: a UI part 111 where a user performs a selection operation; a meta data input part 112 for inputting meta data via the transmission line from a meta data server; a meta data database 113 for managing the meta data database; a use condition input part 114 for receiving and inputting a use condition for converting the meta data and a scene section information input part 115 for receiving and inputting scene section information for converting the meta data, the parts being configured to receive a scenario rule for converting to the meta data in line with the purpose of a content provider; a meta data conversion part 116 for converting the meta data to the meta data in line with the purpose of the content provider, using the use condition or the scene section information; a content input part 117 for receiving and inputting the content via the transmission line from the content server; a content database 118 for storing the content; and a meta data use/reproduction part 119 for reproducing the content using the converted meta.

Within the meta data conversion information providing device 120 there are included: a use condition generation part 121 for generating a use condition and a use condition transmission part 122 for transmitting the generated use condition, the parts being configured to transmit a scenario rule which is a conversion element for converting to the meta data in line with the purpose of a content provider; a scene section information generation part 123 for generating scene section information which is a conversion element for converting to the meta data in line with the purpose of the content provider; and a scene section information transmission part 124 for transmitting the generated scene section information. The meta data conversion information providing device 120, although the content provider generally sets and provides, may be set by an associate who works with the content provider or a person who is authorized by the content provider in various contexts of business operations.

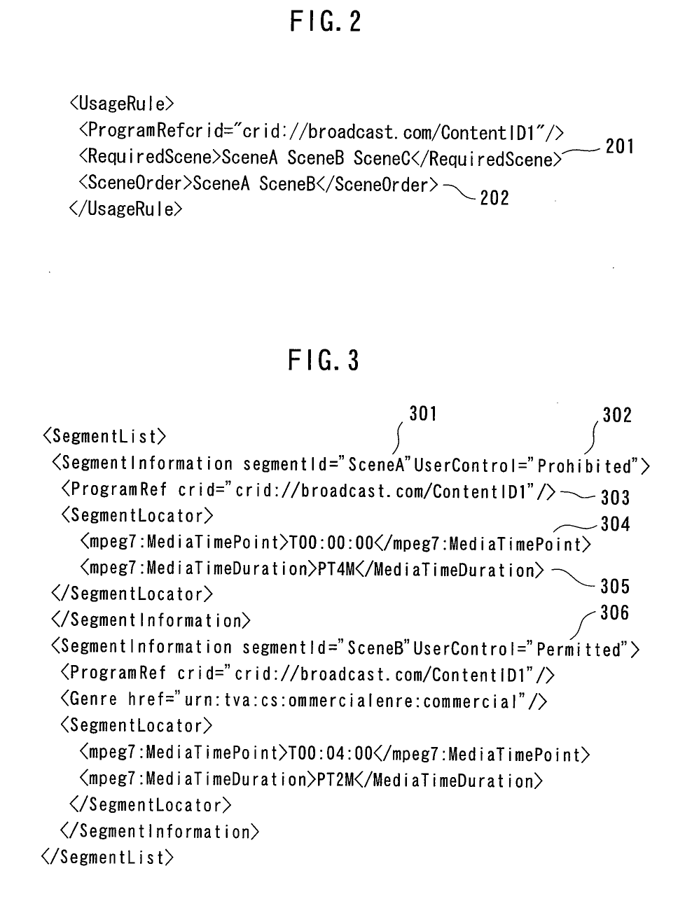

Next, the use conditions generated in the use condition generation part 121 will be described. The use conditions include one that specifies a scene to be viewed as a required scene and one that specifies rearrangement of scenes in the order to be viewed. FIG. 2 shows an example of the use condition described in XML (extensible Markup Language). The required scene is that describes the scene information to be required when using the meta data for digest viewing, which is listed within a tag <RequiredScene> 201. Here, SceneA, SceneB and SceneC are specified as the required scene using a scene identifier for uniquely identifying a specific scene section of the content.

The viewing order describes the order to be viewed and respected by the user when using the meta data for digest viewing. The viewing order is described within a tag <SceneOrder> 202. Here, using the scene identifier for uniquely identifying the scene section, it is shown the viewing order indicating that SceneB is viewed after SceneA. The use condition configured as described above is generated in the use condition generation part 121 and transmitted to the use condition input part 114 via the transmission line from the use condition transmission part 122.

Incidentally, the scene section specification by the use condition may be described in the start and end times of the relevant content or the use condition thereof, instead of being specified using the scene identifier. In addition, the scene identifier may be hierarchically specified with an identifier of the content and a scene identifier. In order to certify that the content provider has generated the use condition, the content provider may add an electronic signature to the use condition or may include in a license containing a use condition and a decryption key for the content of DRM (Digital Right Management) used for the management of digital content copyrights.

Next, the scene section information generated in the scene section information generation part 123 will be described. FIG. 3 shows an example of the scene section information on the content time-divided into units of scenes, which is described in XML based on a server-type broadcasting meta data standard. The scene section information includes: a scene identifier 301 for uniquely identifying the scene section; a content identifier 303 for indicating the content where the scene section is included; a scene start time 304; and a scene end time 305 and the like. In FIG. 3, SceneA is set as the scene identifier, and the content ID is assigned by crid://broadcast.com/ContentID1 in a CRID (Content Reference ID) format used for the server type broadcasting. The start time is defined as 0, and the duration time is defined as 4 minutes. In other words, the scene section defined as SceneA corresponds to 4 minutes from time 0 to 4 minutes of the content that is referred by the content ID crid://broadcst.com/ContentID1.

Incidentally, although the time is directly set in this embodiment, the time period may be set using the number of frames as defined in the server type broadcasting standard, or the time may be set with a relative time. There may be further included a reproduction control information 302, 306 on whether special operations from the user, such as fast-forward, rewind and skip, are permitted. Here, the user special control is prohibited to SceneA and is permitted to SceneB. Although not shown in the figure, a detailed content of the scene section may be described in the scene section information.

The embodiment has shown an example of the scene section information described by the meta data specified in the server type broadcasting. However, it may be described using a content meta data standard such as MPEG-7. The scene section information having such a configuration is generated in the scene section information generation part 123 and is transmitted to the scene section information input part 115 via the transmission line from the scene section information transmission part 124.

Incidentally, although in the above description, the use condition and the scene section information are separately generated and transmitted, the use condition and the scene section information may be transmitted as a scenario rule.

As described above, the meta data conversion information providing device 120 generates and transmits the scenario rule including the use condition and scene section information for converting the meta data by the meta data conversion device 110.

Next, the meta data conversion device 110 will be described. The meta data conversion device 110 receives the scenario rule including the use condition and scene section information for converting the meta data, and thus the meta data is converted in accordance with the scenario rule.

The meta data conversion device 110 receives the use condition in the use condition input part 114 and receives the scene section information in the scene section information input part 115.

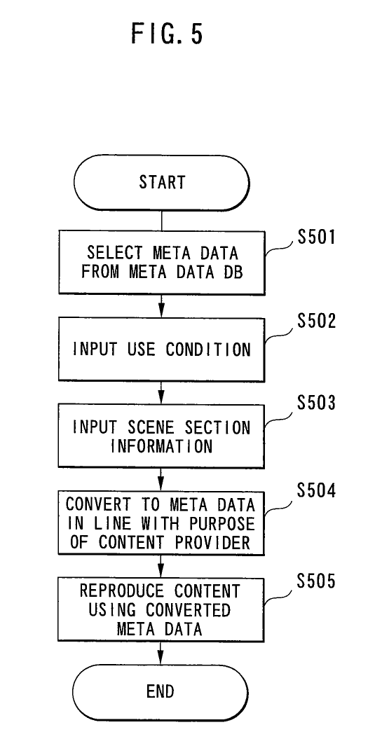

Hereinafter, the description will be made with reference to FIG. 5 on the operation for converting the user-selected meta data to the meta data in line with the purpose of the content provider by inputting the received use condition or scene section information.

The meta data database 113 can store the meta data input in the meta data input part 112. The meta data database 113 can also store the meta data that the user generated using the UI part 111. From the stored meta data, the user selects meta data for the purpose of digest viewing through the operation of the UI part 111. The selected meta data is input to the meta data conversion part 116 (S501). Here the meta data is selected according to the user's preference, so that the selected meta data is not necessarily in line with the intent of the content provider. Next, the use condition input in the use condition input part 114 and the scene section information input in the scene section information input part 115 are input to the meta data conversion part 116 (S502, S503). The selected meta data, use condition and scene section information are input to the meta data conversion part 116. The selected meta data is converted using the input use condition and scene section information (S504). Then, the converted meta data is input to the meta data use/reproduction part 119 that extracts the content from the content database 118 and reproduces the content, based on the converted meta data.

The internal configuration of the meta data conversion part 116 will be described in further detail.

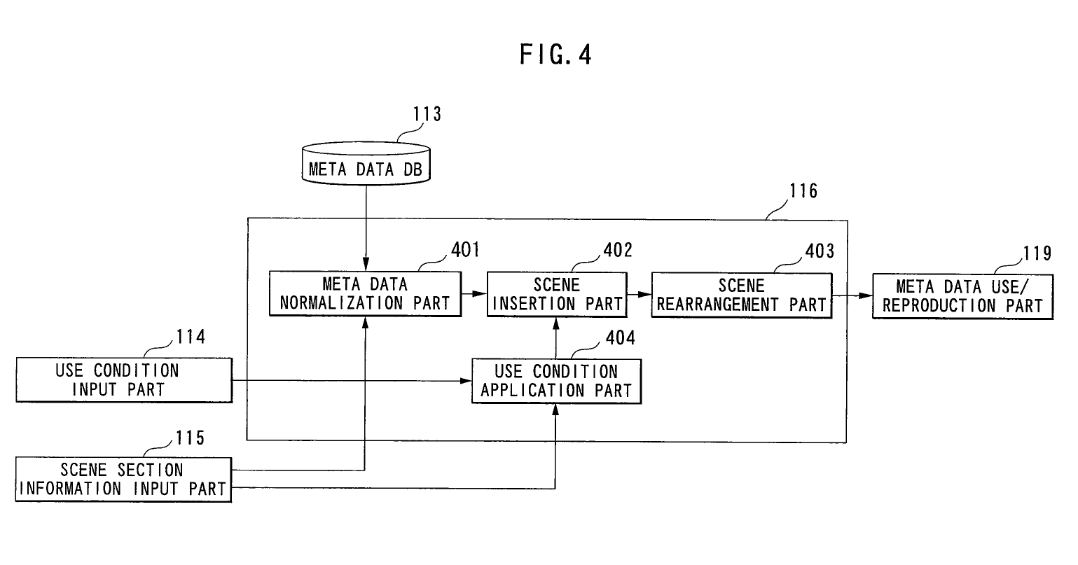

As shown in FIG. 4, the meta data conversion part 116 includes: a meta data normalization part 401 for normalizing the selected meta data based on the scene section information; a scene insertion part 402 for inserting the required scene into the normalized meta data based on the use condition; a scene rearrangement part 403 for rearranging the normalized meta data in the order to be viewed based on the use condition; and a use condition application part 404 for designating respective use conditions to the scene insertion part 402 and the scene rearrangement part 403. The scene section information transmitted from the scene section information input part 115 is input to the use condition application part 404. The scene required when using the normalized meta data and the order to be viewed are applied from the use conditions transmitted from the use condition input part 114. Then, the required scene and the order to be viewed are transmitted to the scene insertion part 402 and the scene rearrangement part 403, respectively.

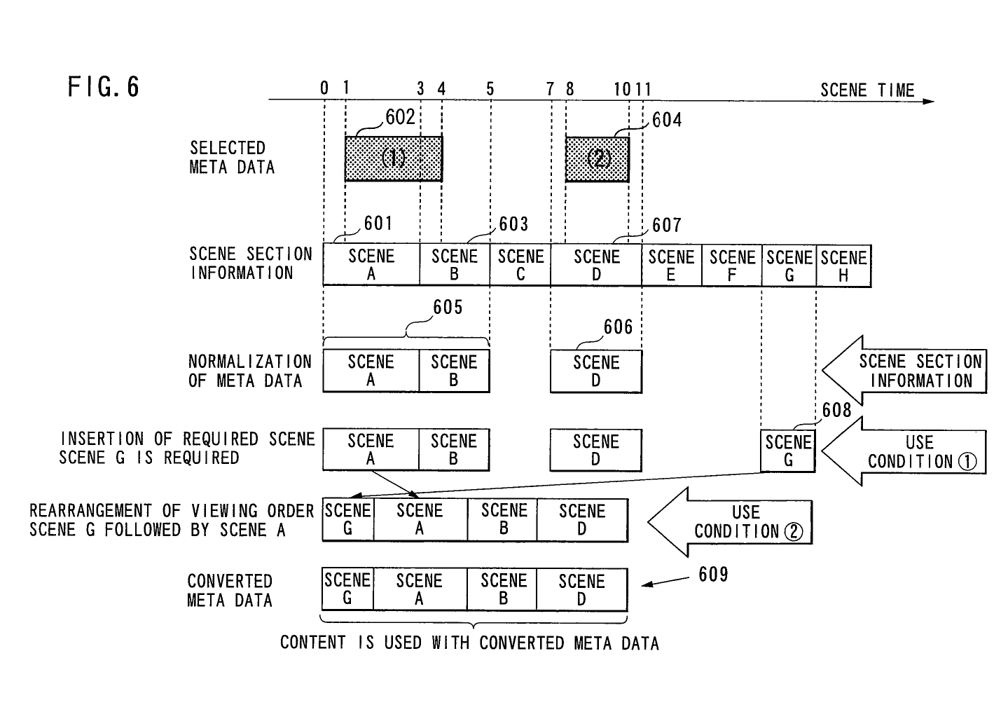

FIG. 6 specifically shows the operation for converting the meta data, which is processed within the meta data conversion part 116 when generating the meta data for digest viewing. It is assumed that the user-selected the meta data (FIG. 13) describing that Scene(1) 602 and Scene(2) 604 are reproduced from the meta data database 113. The meta data shown in FIG. 13 shows that Scene(1) (1301) for 3 minutes from the first minute of the content and Scene(2) (1302) for 2 minutes from the eighth minute of the content are viewed as a digest of the content.

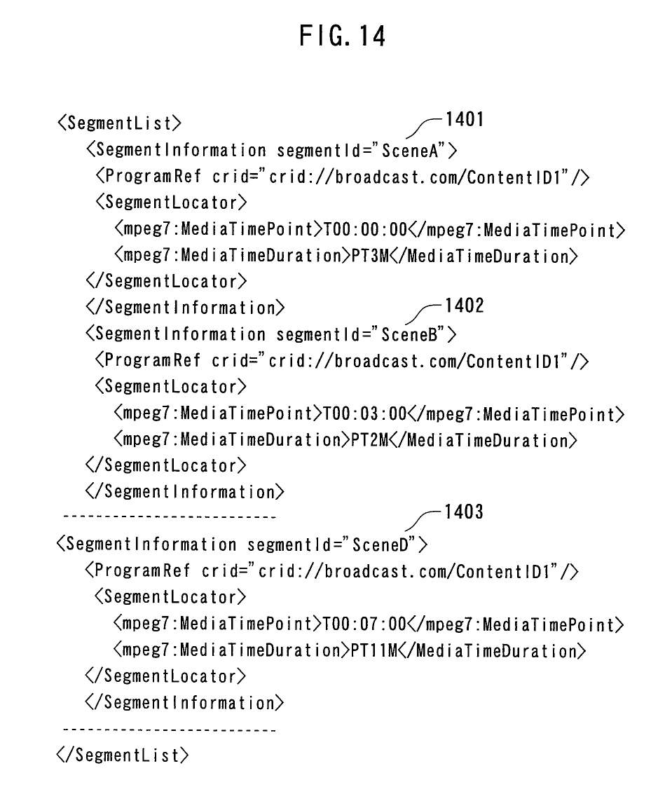

The selected meta data is input to the meta data normalization part 401. The meta data showing that the reproduced scenes, Scene(1) 602 and Scene(2) 604, are viewed as a digest of the content by the selected meta data, as well as the scene section information shown in FIG. 14 are input to the meta data normalization part 401. Thus the user-selected meta data is normalized in the meta data normalization part 401. Normalization is performed as shown in FIG. 6. In the figures, Scene(1) 602, 1301 (1 to 3 minutes) of the user-selected meta data is included in SceneA (0 to 3 minutes) 601, 1401 and SceneB (3 to 5 minutes) 603, 1402, which are defined in the scene section information, so that the meta data is normalized to a scene 605 which is a combination of SceneA 601 and SceneB 603. On the other hand, Scene(2) (8 to 10 minutes) 604, 1302 is only included in SceneD (7 to 11 minutes) 607, 1403 which is defined in the scene section information, so that the meta data is normalized to a scene 606 which is equivalent to SceneD 607. The normalized meta data 605, 606 of the normalized scenes are input to the scene insertion part 402.

In other words, the normalization is to convert the input meta data to the meta data in units of scenes of the scene section information specified by the input scene section information. With the normalization operation as described above, the scenes of the user-selected meta data are taken in the scene section specified by the content provider.

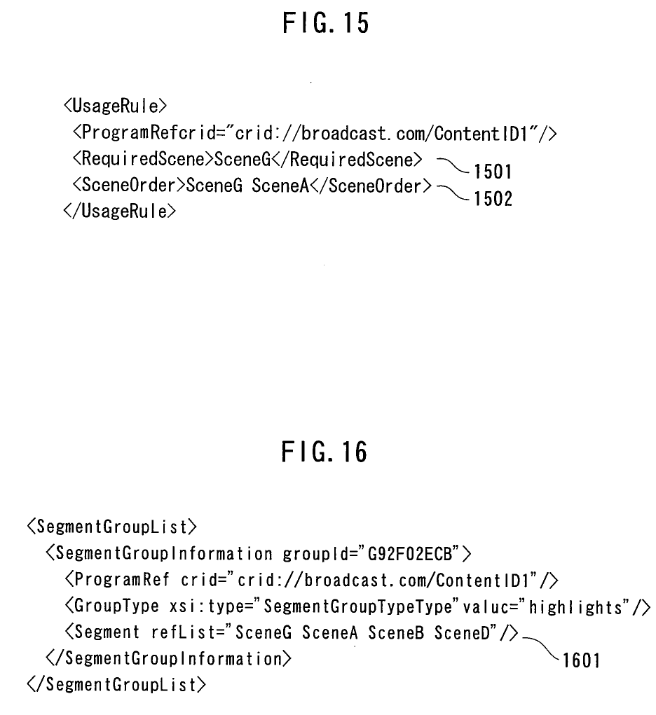

On the other hand, a required scene 1501 of the use condition described in FIG. 15 is input to the scene insertion part 402 from the use condition application part 404. Here SceneG 608 is equivalent to the required scene. The normalized meta data 605, 606 and the required scene 608, which were input to the scene insertion part 402, are input to the scene rearrangement part 403. Then, the scene rearrangement part 403 converts to meta data into which the required SceneG is inserted. Also, scene order information 1502 describing the order to be viewed is input to the scene rearrangement part 403 from the use condition application part 404. Here the information is input describing that SceneA 601 is viewed after SceneG 608. In this case, the meta data into which the required scene was inserted is converted to the meta data (FIG. 16) where the scenes are rearranged in the following order: SceneG 608→SceneA 601→SceneB 603→SceneD 607. Upon reproduction, the converted meta data of FIG. 16 and the scene section information (FIG. 14) specified by the converted meta data are used for the user to view a digest of the content. Incidentally, the converted meta data of FIG. 16 and the scene section information may be converted to a format describing them as one piece of meta data.

Thus, the user-selected meta data for digest viewing is converted by the scenario rule including the use condition and the scene section information which are specified by the content provider. The converted meta data is described in the server-type broadcasting meta data format as shown in FIGS. 7 and 16. In the meta data for digest viewing described in the server-type broadcasting meta data format, there are described a content identifier 701 for uniquely indicating the content where the meta data is included, a title of meta data for digest viewing 702, and a scene order list 703 used for the user to view a digest. In this way, the user can view a digest of the content using the converted meta data.

In the above embodiment, there has been described that the meta data is rearranged according to the viewing order after insertion of the required scene. However, the required scene may be inserted after rearrangement according to the viewing order. In order for the user to respect the reproduction order descried in the meta data, a secure method that cannot be easily altered may be generated before allowing the user to view a digest. Further, the required scene may refer not only to scenes in the same content but also to scenes in other contents.

As described above, in the embodiment, the user-selected meta data is converted to the meta data in line with the purpose of the content provider by applying the required scene and viewing order that the content provider wants to be viewed, and then the content is reproduced using the converted meta data. This makes it possible to provide the user with important scenes such as CM and the logo scene and title of a content creator as required scenes, even if the user selects meta data not including such scenes. Further, although the user arbitrary selects meta data and changes its viewing order, it is possible to provide the user with the meta data rearranged in the order that the content provider wants to be viewed by the user.

Thus, it becomes possible for the user to view without missing the scenes that the provider of content for digest viewing intended and considers important, while respecting the story structure that the provider considers important, even with the meta data generated on the user side.

The content provider will be able to allow the user to view the important scenes (predetermined information such as highlight scenes, CM scenes, and promotion information) in an appropriate manner, even in the case of a digest view of the user generated meta data. As a result, it is possible to allow the user to view the important scenes (highlight scenes, CM scenes) or to view a preview scene for the purpose of promotion, even in the case of a digest view where only part of the content is used.

Further, by specifying the reproduction order of scenes, the content provider will be able to allow the user to view the content in a form suited to the purpose of the content provider, even with the meta data serving as a digest view that may destroy the original purpose of the content of a program, such as a quiz or ranking program when reproduced in reverse order.

As described above, it becomes possible for the user to view without missing the scenes that the provider of content for digest viewing considers important, while respecting the story structure that the provider considers important. It is particularly effective in the meta data generated by the user himself/herself as well as in the meta data shared by users.

Further, through the use of the present invention, the user will be able to use a digest view using the meta data, without missing important scenes due to the scene structure that does not diminish the charm of the content.

### Embodiment 2

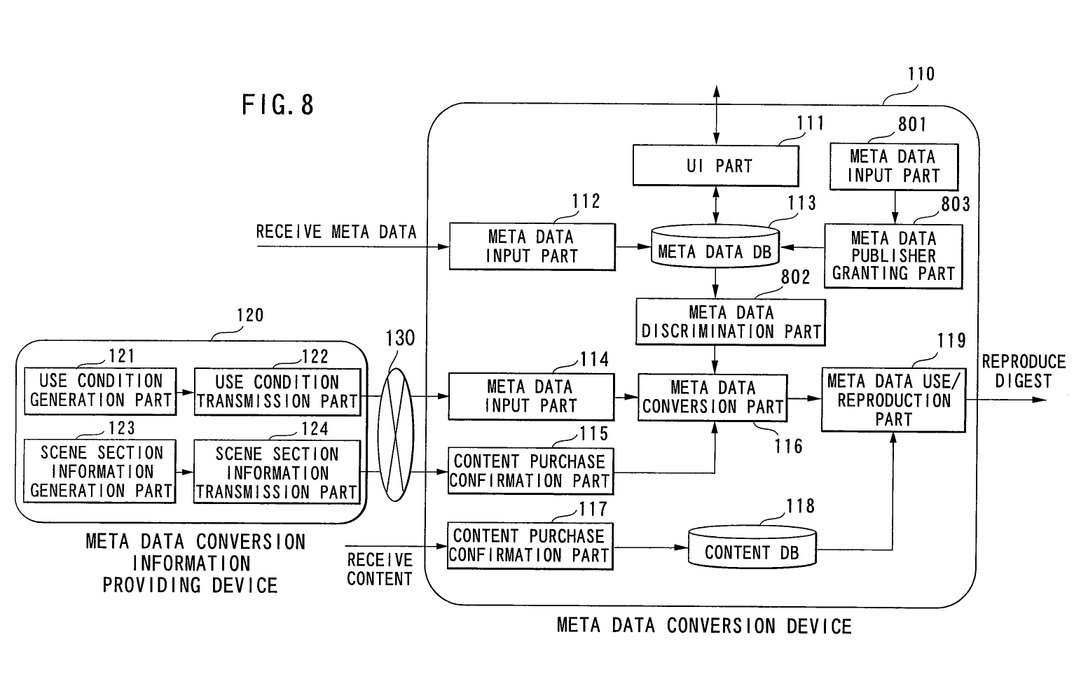

Hereinafter a second embodiment of the invention will be described. As shown in FIG. 8, the meta data conversion system in this embodiment includes a meta data generation part 801, a meta data discrimination part 802, and a meta data publisher granting part 803, in addition to the configuration shown in Embodiment 1. The same components as shown in Embodiment 1 are designated by the same reference numerals and their repeated description will be omitted.

The meta data generation part 801 is a part where the user generates meta data. The user generates meta data by using the UI part 101 to select only part of content the user wants to view, or by selecting meta data from the meta data stored in the meta data database 113 to edit using the selected meta data. In this case, the user generates the meta data by selecting meta data and rearranging the scenes specified by the selected meta data. It is also possible to automatically generate the meta data for digest viewing by extracting scenes according to the user's preference within a user specified period of time, based on the preference information and time information that the user has specified in advance.

Incidentally, at this time, the meta data publisher granting part 803 grants information on the publisher to the meta data, as information for discriminating whether the meta data was generated automatically or through the user operation. The automatically generated meta data may be provided with an electronic signature by a secret key that is unique to the meta data publisher granting part 801 in order to certify that the meta data was automatically generated by the meta data generation part 801.

The meta data database 113 stores the meta data generated by the content provider and transmitted from the meta data input part 112, the meta data generated by the user in a terminal belonging to the user's home network, and the meta data generated by a third party with no relationship to the user or content provider, in addition to the meta data generated by the user in the meta data generation part 801 using the UI part 111.

The meta data discrimination part 802 discriminates the publisher (creator) of the meta data input from the meta data database 113, and determines whether or not to convert the meta data depending on the discrimination result of the publisher. The discrimination of the publisher is obtained from the confirmation of the publisher information granted to the meta data. The meta data discrimination part 802 confirms the electronic signature as a means of confirming the information on the meta data publisher. When it is confirmed that the electronic signature has been provided by the content provider or by a service provider authorized by the content provider, the meta data is transmitted to the meta data use/reproduction part 119. The selected meta data can be used as it is. On the other hand, when it is confirmed that the electronic signature has been provided by someone other than the content provider or by a service provider who is not authorized by the content provider, the required scene and viewing order that the content provider wants to be viewed are applied by the meta data conversion part 116 to the input meta data which is then converted to the meta data in line with the purpose of the content provider.

In addition, the description will be oriented to an example of conversion to meta data in the meta data conversion part 116 depending on the discrimination result of the meta data discrimination part 802.

When the electronic signature can be confirmed by a public key that is unique to the meta data conversion device 102, it is determined that the meta data was generated in the meta data generation part 801. At this time, the information on the publisher of the meta data is used for discriminating whether the meta data was generated by the user or generated automatically.

The description will be oriented to the home network environment where the content and meta data are shared in the home equipment, allowing the shared content to be reproduced and recorded through the home network. In this case, when the meta data can be discriminated as being encrypted by a common key shared within the home network, it is possible to determine that the meta data was generated within the home network. When the electronic signature of the meta data cannot be confirmed, it is determined that the meta data was generated by a third party user. The meta data generated by the third party user, the publisher of which is unclear, is unlikely to be in line with the purpose of the content provider due to low reliability of the publisher, as compared to the above described meta data permitted by the content provider, the meta data generated by the user in the user's terminal, and the meta data generated on the terminal within the home network.

In the above, there has been described an example of the electronic signature as the means of discriminating the meta data. However, the meta data may be discriminated by a secret code or digital watermark using a public key. As a result of the discrimination of the meta data, when it is confirmed that the electronic signature has been provided by someone other than the content provider or by a service provider who is not authorized by the content provider, the required scene and viewing order that the content provider wants to be viewed are applied in a meta data conversion part 116′ to the input data which is then converted to the meta data in line with the purpose of the content provider.

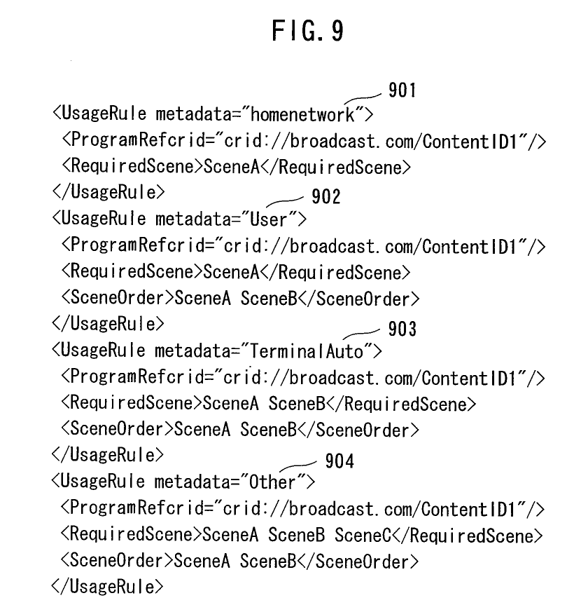

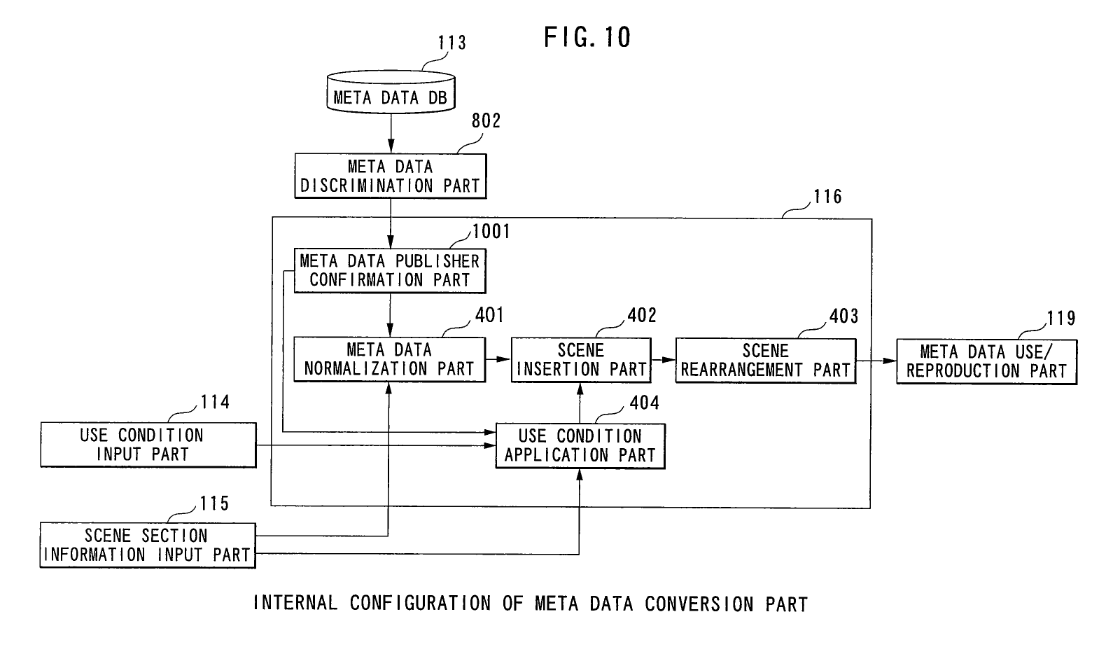

The internal configuration of the meta data conversion part 116′ will be described in further detail. As shown in FIG. 10, the meta data conversion part 116′ in this embodiment includes a meta data publisher confirmation part 1001, in addition to the configuration shown in Embodiment 1. The meta data publisher confirmation part 1001 confirms which use condition is applied depending on the meta data publisher confirmed in the meta data discrimination part 802. As shown in FIG. 9, the meta data the user generated on the home network is converted using a use condition of 901. The meta data the user generated in the meta data generation part 801 is converted using a use condition of 902. The meta data automatically generated in the meta data generation part 801 is converted using a use condition of 903. In addition, the meta data generated by a third party, for example, the meta data which is transmitted from a friend or shared by unspecified persons on the network, is converted using a use condition of 904.

There may be set detailed use conditions, such as the number of viewings of the content, the time when the content is used for digest viewing, and the period of validity for which the use condition is applied. In this case, the information on the view history of the content and on the time when the content was viewed and the like is managed within the meta data conversion device 102. Thus the meta data is converted in accordance with these pieces of information and the use conditions. In this way, the meta data generated by someone other than the content provider or the service provider who is authorized by the content provider is transmitted to the meta data normalization part 401 with the publisher granted thereto. The following operations processed within the meta data conversion part 116′ are the same as the operations described in Embodiment 1.

As described above, in the embodiment, it is possible to determine whether or not to convert the meta data depending on the publisher of the selected meta data and to change the conversion method depending on the publisher of the meta data. Thus, when it is discriminated that the meta data is obtained by the user from a third party through e-mail or other electronic means, or that the meta data is shared by the Web bulletin board function, P2P file sharing or other applications, the user should view many scenes including CM specified by the content provider. However, the content provider can provide a detailed specification indicating that there is no need for the user to view the scenes including CM, to the meta data generated and used by the user himself/herself.

The content provider sets the usage of the meta data for digest viewing depending on the publisher and usage of the meta data. This allows the content provider to increase the chance for the content to be viewed as well as to increase the chance of CM and promotion. On the other hand, there is an advantage that the user can view only necessary scenes or favorite scenes of the content in a short period of time. In addition, another advantage is that it is possible to share a digest view of favorite scenes among users through a network.

### Embodiment 3

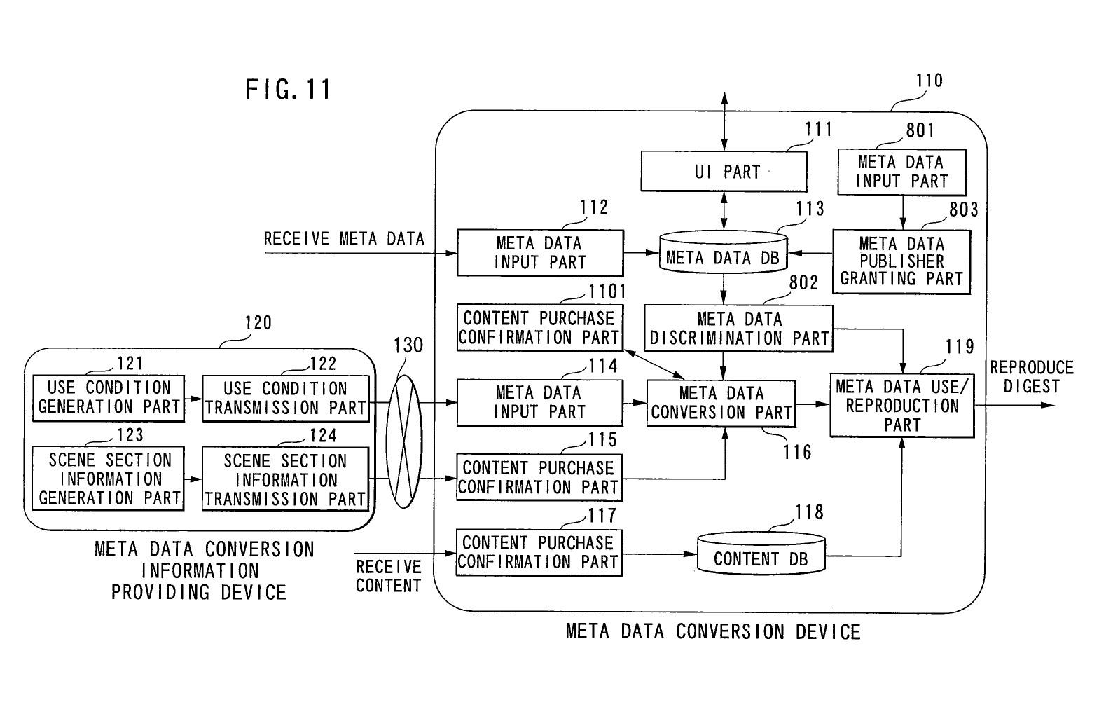

Hereinafter a third embodiment of the present invention will be described. As shown in FIG. 11, the meta data conversion system in this embodiment includes a content purchase confirmation part 1101, in addition to the configuration shown in Embodiment 1 or 2. The same components as shown in Embodiment 1 or 2 are designated by the same reference numerals, and their repeated description will be omitted.

The content purchase confirmation part 1101 confirms whether the content corresponding to the meta data in line with the purpose of the content provider has been purchased to be converted in the meta data conversion part 116. Then the content purchase confirmation part 1101 changes the conversion result in accordance with the purchase confirmation result. The content purchase confirmation part 1101 uses DRM (Digital Right Management) or other tools. Hereinafter, the description will be oriented to the operation for confirming whether the content corresponding to the meta data in line with the purpose of the content provider has been purchased to reproduce the content depending on the purchase confirmation result.

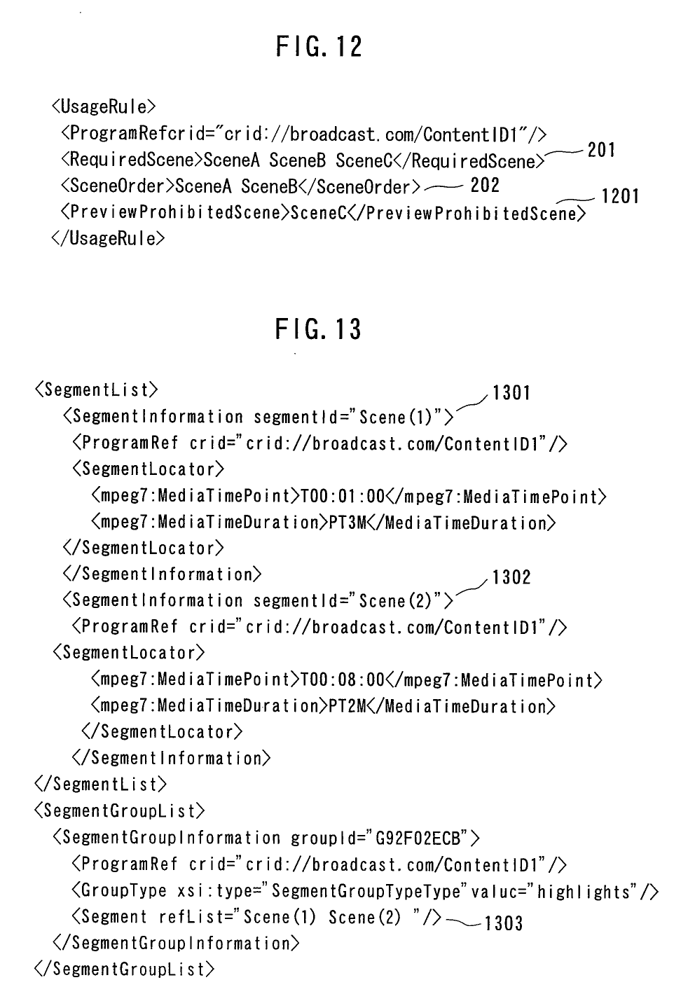

As described above, the user-selected meta data is converted in the meta data conversion part 116 using the use condition and the scene section information, and thus the meta data is generated in line with the purpose of the content provider. In this embodiment, as shown in FIG. 12, the use condition includes a condition of previewing restriction 1201, in addition to the required scene 201 and the viewing order 202.

The meta data conversion part 116 inquires the content purchase confirmation part 1101 whether the content corresponding to the scene section of SceneC has been purchased. When the content has been purchased or a content purchase process is done, the pre-purchase viewing restriction scene (preview prohibited scene) 1201 can be released, allowing the user to view a digest including SceneA, SceneB, and SceneC while respecting the order of SceneA followed by SceneB. When the content has not been purchased and the user does not do the purchase process, the user is not allowed to view a digest including SceneC.

As described above, in the embodiment, in addition to the required scene and viewing order that the content provider wants to be viewed, the viewing restriction is applied to the user-selected meta data which is then converted to the meta data in line with the purpose of the content provider. The converted meta data is designed to be unusable unless the viewing restriction is somehow released. Because of this feature, even in the case where the content corresponding to the user-selected meta data is charged, the user can view a digest by purchasing the relevant content.

In the case where the user has not purchased the content, it becomes possible to allow the user to view a digest under a limited condition, such as preventing the user from viewing highlight scenes.

In Embodiments 1 to 3, there has been described that the meta data after meta data conversion is used when using the meta data for digest viewing, but it may be used when using the segmentation meta data to specify a bookmark used for viewing from the scene halfway through the content.

Further in Embodiments 1 to 3, the scene section information and use condition that constitute the scenario rule are separately transmitted and received, but they may be transmitted as one data using such technology as synthesis and multiplexing.

Further, the drawings used in Embodiments 1 to 3 show that the use condition and scene section information serving as the scenario rule are directly transmitted to the meta data conversion device from the meta data conversion information providing device. However, it is possible to use the use condition and scene section information that are temporarily accumulated in the meta data database 113. The user-selected meta data such as a digest is not necessarily stored in the meta data database.

The present invention is useful for systems using meta data, such as broadcasting systems and content delivery systems, and is particularly useful as an application for server type broadcasting and service, TV Anytime, and the like. The present invention is also applicable to meta data exchange service, automatic digest generation service within the meta data conversion device, and the like.

The present invention has been described based on the preferred embodiments shown by the accompanying drawings. It is apparent that the present invention can be easily changed and modified by those skilled in the art without departing from the spirit and scope of the present invention, and such modifications are intended to be included within the scope of the present invention.

What is claimed is:

1. A meta data conversion device, comprising:
a meta data input part that inputs meta data that describes information on content in units of scenes;
an input part that inputs a scenario rule indicating a conversion method for meta data provided by a content provider; and
a meta data conversion part that converts the input meta data by the conversion method described in the scenario rule.

2. The meta data conversion device according to claim 1, wherein the scenario rule includes a use condition for converting the meta data and scene section information for converting the meta data.

3. The meta data conversion device according to claim 2, wherein the use condition specifies at least one specification, which is a required scene or a scene reproduction order to be viewed.

4. The meta data conversion device according to claim 1, further comprising a meta data discrimination part that discriminates a publisher of the input meta data,
wherein the meta data conversion part changes a conversion result of the meta data converted by the conversion method described in the scenario rule, depending on a discrimination result of the publisher.

5. The meta data conversion device according to claim 1, further comprising a content purchase confirmation part that confirms whether content corresponding to the meta data has been purchased,
wherein the meta data conversion part changes the conversion result of the meta data converted by the conversion method described in the scenario rule, depending on the purchase confirmation result.

6. The meta data conversion device according to claim 2, wherein the meta data conversion part uses the use condition to perform at least one conversion process, which is insertion of the required scene into the meta data or rearrangement of the scenes in the order to be viewed.

7. The meta data conversion device according to claim 2, wherein the meta data conversion part comprises:
a first meta data conversion part that converts the input meta data to meta data in units of scenes of scene section information specified by the input scene section information; and
a second meta data conversion part that converts the meta data converted in the first meta data conversion part, based on the input use condition.

8. A meta data conversion information providing device, comprising:
a meta data conversion information generation part that generates a scenario rule including a use condition and scene section information for converting meta data that describes information on content in units of scenes; and
a transmission part that transmits the scenario rule.

9. A meta data conversion method, comprising the steps of:
inputting a scenario rule to convert meta data in a terminal in accordance with a conversion rule for meta data generated by a content provider;
converting specified meta data using the scenario rule; and
reproducing the content using the converted meta data.

10. The meta data conversion method according to claim 9, further comprising the steps of:
discriminating a publisher of the meta data; and
changing a conversion result depending on a discrimination result of the publisher.

11. The meta data conversion method according to claim 9, further comprising the steps of:
confirming whether content corresponding to the meta data has been purchased; and
changing a conversion result depending on a purchase confirmation result.

12. The meta data conversion method according to claim 9, wherein the step of converting the meta data comprises:
a first meta data conversion step for sorting the input meta data in units of scenes of the scene section information specified by the input scene section information, based on the input scene section information; and
a second meta data conversion step for converting the meta data converted in the first meta data conversion step, based on the input use condition.

13. A digest reproduction device, comprising:
a meta data input part that inputs meta data that describes information on content in units of scenes;
an input part that inputs a scenario rule indicating a conversion method for meta data provided by a content provider;
a meta data conversion part that converts the input meta data by the conversion method described in the scenario rule; and
a meta data use/reproduction part that reproduces the content using the converted meta data.

14. A meta data conversion system comprising:
a meta data conversion information providing device that provides meta data conversion information;
a meta data conversion device that converts meta data; and
a transmission line that connects the meta data conversion information providing device with the meta data conversion device,
wherein the meta data conversion information providing device includes:
a scenario rule generation part that generates a scenario rule generated by a content provider; and
a transmission part that transmits the generated scenario rule,
the meta data conversion device includes:
a use condition input part that receives and inputs the use condition;
a scene section information input part that receives and inputs the scene section information;
a meta data conversion part that converts the meta data using the use condition or the scene section information, and
a meta data use/reproduction part that reproduces the content using the converted meta data.
